(19) United States
(12) Patent Application Publication
(10) Pub. No.: US 2016/0107549 A1
(43) Pub. Date: Apr. 21, 2016

(54) VEHICLE SEAT SUBSTRUCTURE WITH AN ACCIDENT-INDUCED ADJUSTMENT DEVICE

(71) Applicant: JOHNSON CONTROLS GMBH, Burscheid (DE)

(72) Inventors: Jaroslav JANICEK, Bytca (SK); Martin HUDÁK, Dolna Suca (SK); Pinto Thomas CHIRAYATH, Leichlingen (DE)

(21) Appl. No.: 14/897,370

(22) PCT Filed: Jun. 10, 2014
(86) PCT No.: PCT/EP2014/061979

§ 371 Date: Dec. 10, 2015

(30) Foreign Application Priority Data
Jun. 14, 2013 (DE) 10 2013 106 250.4

(51) Int. Cl. B60N 2/42; B60N 2/427; B60N 2/16; B60N 2/07

(52) U.S. Cl. CPC B60N 2/43; B60N 2/0722; B60N 2/42736; B60N 2/1615

(57) ABSTRACT

A vehicle seat substructure has an accident-induced adjustment device including a pair of seat rails having a seat top rail arranged displaceably in relation to a seat bottom rail, and a seat structure arranged pivotably on the seat top rail via a fitting element. The vehicle seat substructure reliably permits the vehicle seat to be fixed along the pair of seat rails in the event of an accident and prevents lowering of the vehicle seat due to forces caused by the accident. The construction is simple to mount and cost-effective to produce and at the same time has little susceptibility to failure and can also be installed completely below any vehicle seat. The fitting element, on the seat top rail and on the seat structure, has a fixing element arranged on the fitting element that passes into a locking position locking the seat top rail to the seat bottom rail.

### CROSS REFERENCE TO RELATED APPLICATIONS

This application is a United States National Phase Application of International Application PCT/EP2014/061979 filed Jun. 10, 2014 and claims the benefit of priority under 35 U.S.C. §119 of German Patent Application 10 2013 106 250.4 filed Jun. 14, 2013 the entire contents of which are incorporated herein by reference.

### FIELD OF THE INVENTION

The invention relates to a vehicle seat substructure having an accident-induced adjustment device, comprising
a pair of seat rails having an upper seat rail arranged in a displaceable manner with respect to a lower seat rail, and
a seat structure that is arranged on the upper seat rail in a pivotable manner via a fitting element.

### BACKGROUND OF THE INVENTION

Vehicle seat substructures of the type mentioned at the beginning are known in a wide variety of configurations from the prior art and are used for the adjustable, in particular vertically adjustable, pivotable and/or displaceable arrangement of a vehicle seat on a vehicle structure.

A purpose of such a vehicle seat substructure can be to compensate at least partially for the forces that act on the vehicle seat in the event of a traffic accident or to bring the vehicle seat into a position in which the risk of injury to a passenger sitting on the vehicle seat is reduced to the best possible extent, for which reason it is generally at the same time desired to secure the position of the vehicle seat with respect to the vehicle structure.

To this end, known prior art devices use in particular mechanisms which have a hook arranged on the vehicle seat, said hook being intended to interact with a pin arranged on a lower seat rail of a pair of seat rails or of the vehicle structure. However, these devices have the disadvantage that, until the hook engages with the pin, in particular depending on the particular adjustment of the vehicle seat on a pair of seat rails arranged therebeneath, the vehicle seat is initially accelerated considerably and subsequently stopped abruptly by the contact between the hook and pin, with the result that the risk of injury for a passenger arises again. Furthermore, such a catching system is only reliable to a limited extent, in particular when, in the event of a traffic accident, forces in different spatial directions occur.

In addition to such a catching system which secures the vehicle seat with respect to the vehicle structure, an additional mechanism which prevents the vehicle seat from being pivoted backward on account of forces that arise as a result of an accident is usually required. To this end, it is known, in particular from the prior art, to arrange bearing surfaces laterally on the vehicle seat, said bearing surfaces coming into contact with a surface of the pair of seat rails arranged laterally next to the vehicle seat in the event of the vehicle seat being pivoted backward as a result of an accident, and in the process preventing further pivoting beyond the surface of the pair of seat rails. However, such a device has the disadvantage that in this case the pair of seat rails absolutely has to be arranged to the side of the vehicle seat, or all of the components of the vehicle seat and of the vehicle seat substructure have to be manufactured in a manner coordinated with one another, with the result that series production of a standardized vehicle seat substructure for different vehicle seats is no longer possible.

### SUMMARY OF THE INVENTION

An Therefore, the invention is based on the object of providing a vehicle seat substructure which makes it possible to reliably fix a vehicle seat along a pair of seat rails in the event of an accident and at the same time easily prevents the vehicle seat from dropping on account of accident-related forces, wherein the construction is easy to assemble and cost-effective to produce, at the same time has little susceptibility to faults and in the process can also be installed entirely beneath any desired vehicle seat.

The vehicle seat substructure according to the invention has an accident-induced adjustment device comprises a pair of seat rails comprising an upper seat rail arranged in a displaceable manner with respect to a lower seat rail, and a seat structure that is arranged on the upper seat rail in a pivotable manner via a fitting element. The fitting element is configured and arranged on the upper seat rail and on the seat structure such that, in the event of an accident, a fixing element arranged on the fitting element passes into a locking position locking the upper seat rail to the lower seat rail.

As a result of the arrangement of a fixing element on the fitting element that is pivotable with respect to the upper seat rail and to the seat structure, the upper seat rail is secured with respect to the lower seat rail in a particularly simple manner and at the same time further dropping of the seat structure connected to the fitting element beyond the contact of the fixing element with the pair of seat rails is effectively prevented, wherein a technically complex modification to the construction of the fitting element or of the pair of seat rails is not necessary, with the result that the vehicle seat substructure according to the invention can be produced in a particularly cost-effective manner and can be mounted particularly easily. In addition, the low number of structural elements of the vehicle seat substructure according to the invention advantageously results in low susceptibility to faults. Finally, the arrangement of the fixing element on the fitting element connected to the seat structure and the upper seat rail makes it possible for the pair of seat rails not to be arranged only to the side of the seat structure, as in known prior art devices, but also therebeneath, wherein the action of the fixing element continues to be ensured in an unrestricted manner.

In principle, the vehicle seat substructure can be formed from any desired number of components and have any desired functions. In this case, a vehicle seat substructure is initially understood to mean any construction which is originally formed to be arranged under a vehicle seat. Preferably, the seat substructure is in this case formed as a multipart assembly made of metal, for instance steel or aluminum, plastics material, a composite material and/or a fiber-reinforced material.

In particular, the vehicle seat substructure according to the invention has an accident-induced adjustment device, wherein the adjustment device can be intended in principle to adjust a vehicle seat arranged on the seat substructure in translation and/or rotation about one or more axes or in one or more spatial directions.

The adjustment device allows at least one pivoting movement of the vehicle seat with respect to a vehicle structure, wherein the adjustment device can be constructed both in such a way that pivoting only takes place on account of the forces that arise in the event of a traffic accident, and in such a way that pivoting can additionally also take place by way of a user intervention.

In this case, the vehicle seat substructure according to the invention has at least one pair of seat rails formed from an upper seat rail and a lower seat rail, wherein the two seat rails can be displaced at least in one spatial direction with respect to one another. Preferably, the displacement of the seat rails with respect to one another takes place on a straight path; however, a curved course of the pair of seat rails is also conceivable. The lower seat rail is preferably connected fixedly to the vehicle structure, while the upper seat rail is arranged on the seat structure directly or via further components. Preferably, a pair of seat rails is arranged on each side of the vehicle seat.

In this case, the pair of seat rails can in principle consist of any desired material, for instance a metal, a plastics material or a composite material, have as many components as desired and fulfill functions that go beyond displacement of the upper seat rail with respect to the lower seat rail. Preferably, however, the upper seat rail and/or the lower seat rail are formed integrally.

In this connection, the seat structure is understood to mean at least the components of the vehicle seat which provide the vehicle seat with a structure, in particular a seat and/or backrest frame and associated supporting and/or cushion elements. Furthermore, the seat structure can also be formed for example from an integral or multipart shell and/or comprise armrests, a headrest, safety devices such as airbags or belt elements and further added parts.

Similarly, the vehicle structure is understood to mean the components of a vehicle which constitute at least the basic structure of the vehicle, in particular the body and/or the vehicle frame.

The vehicle seat substructure according to the invention furthermore has at least one fitting element which is arranged in a pivotable manner on the upper seat rail and/or on the seat structure. In this case, the fitting element can in principle be an integral component or an assembly of as many components as desired. The fitting element is in this case formed from materials that are known in vehicle construction, in particular metal, plastics material or a composite material and can fulfill further functions that go beyond the pivotable arrangement of the seat structure on the upper seat rail. In the case of a parallel arrangement of two pairs of seat rails as part of the vehicle seat substructure, at least one pivotable fitting element is preferably arranged on each of the two upper seat rails.

Finally, the vehicle seat substructure according to the invention comprises a fixing element which is arranged on the fitting element or is formed integrally therewith. In this case, the fixing element can initially be formed from any desired material, and preferably is formed from a hard, deformation-resistant material, for instance a metal, in particular steel, or a composite material, for instance fiber-reinforced plastics material. Preferably, the fixing element is formed as a web or as an edge protruding from the fitting element.

According to an advantageous development of the invention, the fixing element is configured such that, in the locking position, it secures the upper seat rail to the lower seat rail in a force-fitting manner, with the result that further movement of the upper seat rail with respect to the lower seat rail is prevented in a particularly simple manner.

According to a further advantageous development of the invention, in the locking position, the fixing element is arranged in a clamping manner between the upper seat rail and the lower seat rail, wherein, at the transition into the locking positions, the fixing element preferably passes between two surfaces, guided on one another, of the lower seat rail and the upper seat rail, thereby achieving reliable, force-fitting securing.

According to a preferred configuration of the vehicle seat substructure according to the invention, in the locking position, the fixing element deforms at least a part of the lower seat rail, preferably at the same time also a part of the upper seat rail. In particular, securing takes place by way of irreversible deformation of the lower seat rail and/or of the upper seat rail, with the result that particularly stable, at least partially also form-fitting securing is achieved in a simple manner, and also, as a result of the deformation of the components, the forces that act on the vehicle seat in the event of a traffic accident are already partially dissipated and thus the risk of injury to a passenger on the vehicle seat is reduced.

According to an advantageous development of the invention, the fitting element is formed in two parts, wherein the fitting element preferably comprises at least one fitting part and a toothed wheel segment. A two-part configuration of the fitting element makes it possible to form that part of the fitting element that has to withstand particularly high loads or, on account of particularly high forces acting on the component, is subjected to increased wear, from a particularly high-performance material, while the remaining part of the fitting element can be formed from a conventional and thus cost-effective material.

In this case, a toothed wheel segment is initially understood to mean in principle any component which has a plurality of teeth arranged next to one another, wherein the teeth can be arranged both along a circular arc segment and in any other desired manner. Preferably, the toothed wheel segment has a plurality of teeth arranged along a circular arc, preferably in an arc segment of between 10° and 45°, and is formed from a particularly abrasion-resistant material, in particular a high-strength metal.

In addition to secure and controlled guidance by means of the meshing of the toothed wheel segment with a further toothed component, the toothed wheel segment can also fulfill further functions. These include for example the reinforcement of a region of the fitting element in which said fitting element is arranged on the upper seat rail and/or on the seat structure, wherein such reinforcement can take place in particular around a part of the circumference or the entire circumference of an opening in the fitting element in order to receive an axle, a pin, a shaft or some other fastening means for pivotable arrangement.

According to a preferred configuration of the invention, the fixing element is formed integrally with the fitting element, preferably integrally with the fitting part of the fitting element, with the result that particularly simple and cost-effective production is possible and at the same time the simple structure ensures high functional reliability.

According to an advantageous development of the invention, the toothed wheel segment is arranged fixedly on the fitting part and interacts with a further component of the vehicle seat such that it is possible to adjust the height or inclination of the vehicle seat with respect to the lower seat rail by means of the fitting element.

In this case, the toothed wheel segment can be connected to the fitting part of the fitting element in any desired manner, wherein preferably the toothed wheel segment bears flatly against a part of the fitting part at least in portions. A force-fitting and/or cohesive and/or form-fitting connection, for instance by adhesive bonding, welding or hot soldering, by means of a fastening means such as a rivet, a pin, a screw, a bolt or in some other way, is conceivable for connecting the two parts.

According to a particularly preferred embodiment of the vehicle seat substructure according to the invention, the fitting element, in particular the fitting part of the fitting element, is formed as a structural element which is angled at least twice, wherein one of the angled parts of the fitting element forms the fixing element, with the result that the fixing element is connected to the fitting element in a particularly stable and inseparable manner and thus ensures high functional reliability. In this case, both a portion of the fitting element and the fitting element can be angled over the entire width, wherein both angling twice at right angles in opposite directions and angling twice at any desired angle in the same direction is conceivable. The fixing element is in this case preferably formed as a straight, non-angled component which particularly preferably has a planar outer face on both sides.

Very particularly preferably, the fitting element is angled twice such that, in the locking position, a first angled face of the fitting element passes as the fixing element between the upper seat rail and lower seat rail, while a second angled face comes into contact at least partially, preferably contiguously, with a surface of one of the two seat rails, preferably the upper seat rail.

According to an advantageous development of the invention, the fitting element is arranged so as to be pivotable in each case both with respect to the upper seat rail and with respect to the seat structure, wherein the fitting element is preferably connected to the seat structure via an axle which extends in particular in the seat transverse direction, it then being possible in a particularly easy manner to arrange the pair of seat rails entirely beneath the seat structure.

In this way, a vehicle seat, in particular a motor vehicle seat, having a vehicle seat substructure according to the invention preferably has at least one pair of seat rails arranged entirely beneath a seat surface of the vehicle seat such that the seat structure, in particular a seat frame of the seat surface, is located entirely above the pair of seat rails with respect to the installation position of the vehicle seat in a motor vehicle, even with the fixing element in the locking position, with the result that the vehicle seat structure can have any desired shape without the functionalities of the vehicle seat substructure and in particular the accident-induced adjustment device being impaired.

A number of exemplary embodiments of the invention are explained in more detail in the following text with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective illustration of a detail of a first embodiment of a vehicle seat substructure;

FIG. 2 is a rotated perspective illustration of the exemplary embodiment, illustrated in FIG. 1, of the vehicle seat substructure;

FIG. 3 is a perspective illustration of a general view of the embodiment, illustrated in FIG. 1, of the vehicle seat substructure;

FIG. 4 is a perspective illustration from two viewing directions of a fitting element of the embodiment, illustrated in FIG. 1, of the vehicle seat substructure with the fixing element arranged thereon;

FIG. 5 is a series of perspective illustrations of a detail of the embodiment, illustrated in FIG. 1, of the vehicle seat substructure in chronological sequence during the transition of the fitting element into a locking position;

FIG. 6 is a perspective illustration from two viewing directions of a fitting element of a second embodiment of the vehicle seat substructure; and

FIG. 7 is a schematic view of a detail of a vehicle seat having a pair of seat rails, arranged entirely beneath a seat surface of a vehicle seat, of the vehicle seat substructure.

### DESCRIPTION OF THE PREFERRED EMBODIMENTS

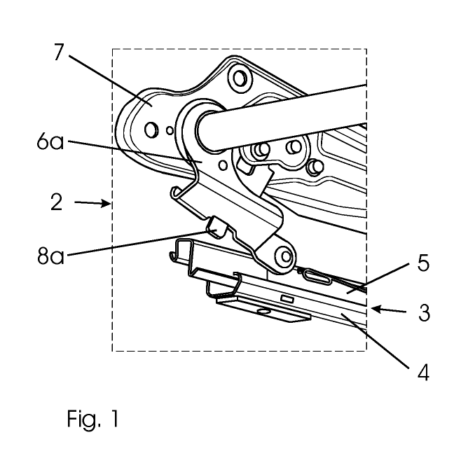

A first embodiment of a vehicle seat substructure 1, a detail of which is illustrated in FIG. 1, has a fitting element 6a which is secured in an articulated manner to an upper seat rail 5 of a pair of seat rails 3 on one side and to an axle 12 of a seat structure 7 on the other side. In this case, the fitting element 6a comprises, on one side, which faces a lower seat rail 4 of the pair of seat rails 3, a fixing element 8a in the form of a rectangular web protruding from the surface of the fitting element 6a.

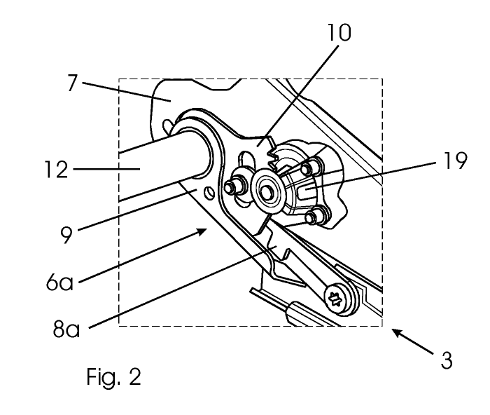

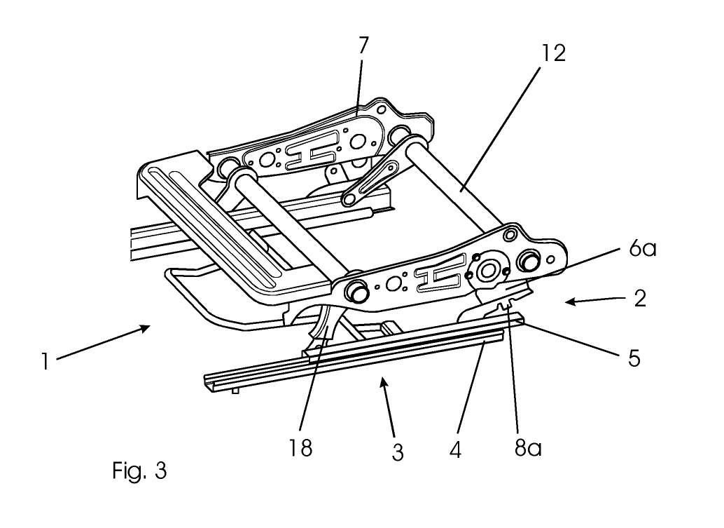

The fitting element 6a is formed from two components, a fitting part 9 and a toothed wheel segment 10, that are connected cohesively together (FIG. 3), wherein the toothed wheel element 10 interacts with a structural unit 19 arranged fixedly on the seat structure 7 in order to drive the fitting element 6a or to damp the latter (FIG. 2).

As illustrated in FIG. 3, the entire vehicle seat substructure 1 has two pairs of seat rails 3 arranged parallel to one another on each of the two sides of the seat structure 7, said pairs of seat rails each comprising a lower seat rail 4 arranged fixedly on a vehicle structure and an upper seat rail 5 arranged displaceably on said lower seat rail 4. The seat structure 7 is arranged above the two pairs of seat rails 3 by means of a total of four fittings 6a, 18, wherein the two fitting elements 6a located on the rear side of the vehicle seat are arranged in an articulated manner both on the upper seat rail 5 and on the vehicle structure 7, while the front fittings 18 are connected fixedly to the upper seat rail 5 and can be pivoted only with respect to the seat structure 7.

The fitting element 6a formed in two parts comprises a fitting part 9 which is formed integrally from sheet metal by stamping and being bent twice. A toothed wheel segment 10 is arranged thereon in a manner overlapping a part of the surface of the fitting part 9, said toothed wheel segment 10 protruding beyond the surface of the fitting part 9 at least in the region of its toothing 20.

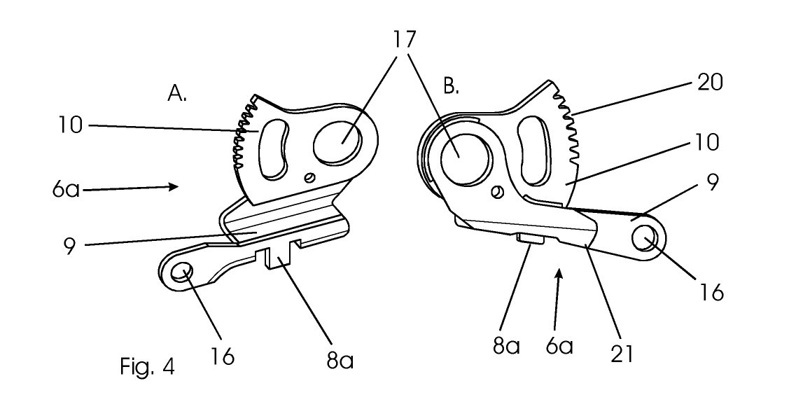

In this case, the fitting part 9 has a cutout 16 for receiving a fastening means on the upper seat rail 5, and an axle receiving opening 17 for arranging on an axle 12 connected fixedly to the seat structure 7, wherein the toothed wheel segment 10 is arranged on the fitting part 9 and fastened such that an opening likewise integrally formed thereon and identical to the axle receiving opening 17 of the fitting part 9 comes to lie congruently over said axle receiving opening 17 (FIG. 4).

The toothed wheel segment 10 is formed from a much stronger material, for example a steel, than the fitting part 9, which can consist of sheet metal.

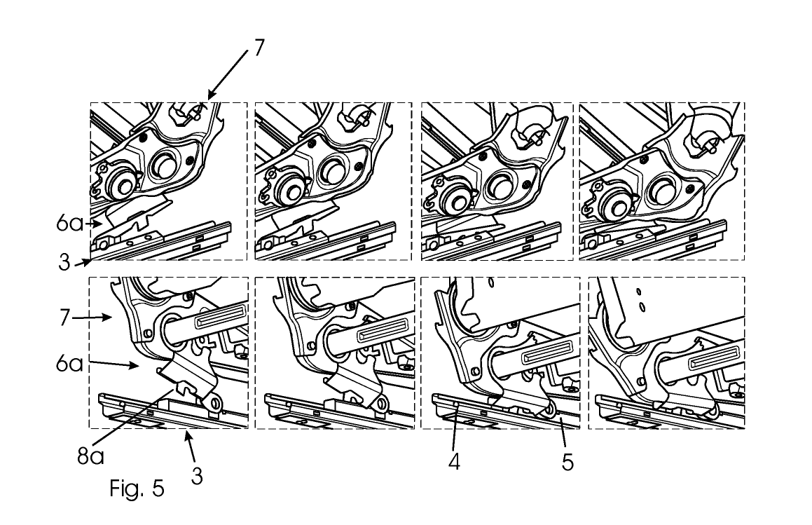

Pivoting of the fitting element 6a in the event of a traffic accident is illustrated in chronological sequence in the depictions in FIG. 5. In this case, in the regular use position of the fitting element 6a, the fixing element 8a arranged on the latter and the pair of seat rails 3 are spaced apart from one another. On account of the forces that occur in the event of a traffic accident, a part, facing the rear side of the vehicle, of the seat structure 7 is lowered by pivoting of the fitting element 6a such that the fixing element 8a passes into a gap between the lower seat rail 4 and upper seat rail 5, wherein it irreversibly deforms the two seat rails 4, 5 and as a result secures the upper seat rail 5 with respect to the lower seat rail 4.

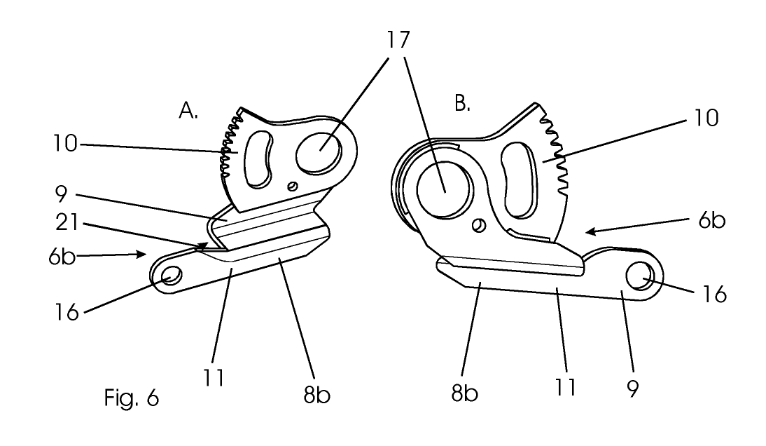

A fitting element 6b of a second embodiment of a vehicle seat substructure 1 differs from the fitting element 6a of the first embodiment of a vehicle seat substructure 1 in that the fitting part 9 does not extend in a manner angled at least twice in the same spatial direction (FIG. 4), but is initially bent approximately at a right angle in one direction and then extends likewise in a manner curved approximately at a right angle in the opposite direction (FIG. 6), with the result that the lower edge of the fitting element 6b, said lower edge adjoining the cutout 16 for arranging on the upper seat rail 5, can already be used as a fixing element 8b, without having to be specially shaped further.

The fitting elements 6a, 6b of both the first embodiment (FIG. 4) and the second embodiment (FIG. 6) in this case have, on account of being angled twice in each case, a planar surface portion which, when a fitting element 6a, 6b is mounted on the upper seat rail 5, can be brought into full contact with the surface of this upper seat rail 5, and thus serves as a stop surface 21 in the event of a traffic accident (FIG. 5).

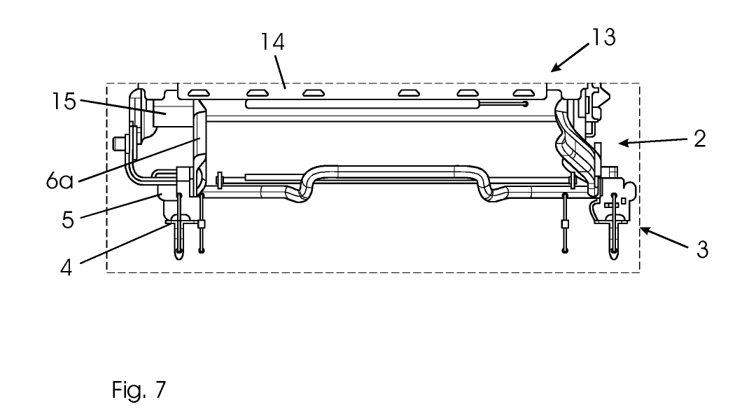

The stop surface 21 integrally formed on the fitting element 6a, 6b and the possibility of arranging the fitting element 6a, 6b in a pivotable manner on an axle 12 fastened to the seat structure 7 make it possible to arrange one or both of the pairs of seat rails 3 entirely beneath the seat surface 14 of the vehicle seat 13 (FIG. 7), with the result that a particularly space-saving design of the vehicle seat substructure 1 is possible and also nothing stands in the way of an asymmetrical arrangement of the two pairs of seat rails 3 with respect to the seat frame 15.

While specific embodiments of the invention have been shown and described in detail to illustrate the application of the principles of the invention, it will be understood that the invention may be embodied otherwise without departing from such principles.

1. A vehicle seat substructure having an accident-induced adjustment device, comprising:
a pair of seat rails having an upper seat rail arranged in a displaceable manner with respect to a lower seat rail;
a fitting element;
a fixing element arranged on the fitting element; and
a seat structure is arranged on the upper seat rail in a pivotable manner via the fitting element wherein the fitting element is configured and arranged on the upper seat rail and on the seat structure such that, in the event of an accident, the fixing element, arranged on the fitting element, passes into a locking position locking the upper seat rail to the lower seat rail.

2. The vehicle seat substructure as claimed in claim 1, wherein the fixing element is configured such that, in the locking position, the fixing element force fit secures the upper seat rail to the lower seat rail.

3. The vehicle seat substructure as claimed in claim 1, wherein, in the locking position, the fixing element is arranged clamped between the upper seat rail and the lower seat rail.

4. The vehicle seat substructure as claimed in claim 1, wherein, in the locking position, the fixing element deforms at least a part of the lower seat rail, and also deforms at least a part of the upper seat rail.

5. The vehicle seat substructure as claimed in claim 1, wherein the fitting element is formed in at least two parts, wherein the fitting element comprises at least one fitting part and a toothed wheel segment.

6. The vehicle seat substructure as claimed in claim 1, wherein the fixing element is formed integrally with the fitting part of the fitting element.

7. The vehicle seat substructure as claimed in claim 1, wherein the toothed wheel segment is arranged fixedly on the fitting part and interacts with a further structural unit of the vehicle seat such that it is possible to adjust the height or inclination of the vehicle seat with respect to the lower seat rail by means of the fitting element.

8. The vehicle seat substructure as claimed in claim 1, wherein the fitting part of the fitting element is formed as a structural element which is angled at least twice, wherein one of angled parts of the fitting element forms the fixing element.

9. The vehicle seat substructure as claimed in claim 1, further comprising an axle wherein the fitting element is arranged so as to be pivotable in each case with respect to the upper seat rail and with respect to the seat structure, wherein the fitting element connected to the seat structure via the axle.

10. A motor vehicle seat comprising a vehicle seat substructure having an accident-induced adjustment device comprising:
a pair of seat rails having an upper seat rail arranged in a displaceable manner with respect to a lower seat rail;
a fitting element;
a fixing element arranged on the fitting element; and
a seat structure arranged on the upper seat rail in a pivotable manner via the fitting element wherein the fitting element is configured and arranged on the upper seat rail and on the seat structure such that, in the event of an accident, the fixing element, arranged on the fitting element, passes into a locking position locking the upper seat rail to the lower seat rail.

11. The vehicle seat as claimed in claim 10, wherein:
the seat structure comprises a seat frame; and
at least one pair of seat rails is arranged entirely beneath a seat surface of the vehicle seat such that the seat frame of the seat surface, is located entirely above the pair of seat rails with respect to the installation position of the vehicle seat in a motor vehicle, even with the fixing element in the locking position.

12. The vehicle seat as claimed in claim 11, wherein the fixing element is configured such that, in the locking position, the fixing element force fit secures the upper seat rail to the lower seat rail.

13. The vehicle seat as claimed in claim 11, wherein, in the locking position, the fixing element is arranged clamped between the upper seat rail and the lower seat rail.

14. The vehicle seat as claimed in claim 11, wherein, in the locking position, the fixing element deforms at least a part of the lower seat rail and also deforms at least a part of the upper seat rail.

15. The vehicle seat as claimed in claim 11, wherein the fitting element comprises at least one fitting part and a toothed wheel segment.

16. The vehicle seat as claimed in claim 11, wherein the fixing element is formed integrally with the fitting part of the fitting element.

17. The vehicle seat as claimed in claim 11, wherein the toothed wheel segment is arranged fixedly on the fitting part and interacts with a further structural unit of the vehicle seat such that it is possible to adjust the height or inclination of the vehicle seat with respect to the lower seat rail by means of the fitting element.

18. The vehicle seat as claimed in claim 11, wherein the fitting element, in particular the fitting part of the fitting element is formed as a structural element which is angled at least twice, wherein one of the angled parts of the fitting element forms the fixing element.

19. The vehicle seat as claimed in claim 11, further comprising an axle wherein the fitting element is arranged so as to be pivotable in each case with respect to the upper seat rail and with respect to the seat structure, wherein the fitting element connected to the seat structure via the axle.
